(19) United States
(12) Patent Application Publication
(10) Pub. No.: US 2011/0022614 A1
(43) Pub. Date: Jan. 27, 2011

(54) TELECOMMUNICATIONS SERVICES APPARATUS AND METHOD

(75) Inventor: Jeffrey Wilson, Southampton (GB)

Correspondence Address: Vierra Magen Marcus & DeNiro LLP, 575 Market Street, Suite 2500, San Francisco, CA, 94105, US

(73) Assignee: INTELLPROP LIMITED, St. Peter Port (GB)

(21) Appl. No.: 12/668,816

(22) PCT Filed: Jul. 11, 2008
(86) PCT No.: PCT/GB2008/002395

§ 371 Date: Apr. 23, 2010

(30) Foreign Application Priority Data
Jul. 13, 2007 (GB) 0713692.2
Jul. 11, 2008 (GB) PCT/GB2008/002395

(51) Int. Cl. G06F 17/30

(52) U.S. Cl. 707/758; 707/E17.014

(57) ABSTRACT

A telecommunications service or application has associated with it a set of exceptions which, in effect, define a set of matchable inputs from a user and corresponding (answer) functions to be performed in the event of the particular input. Each exception has defined for it a text string or strings that a text string derived from an input text message must match for the exception to be matched, and has associated with it a corresponding answer function for the exception. An input user text message (50) is tested against a list (51) of exceptions sequentially until a match is found, and then the corresponding answer function is executed. If no explicit match is found, then the system automatically executes a default answer function. The matched answer function may contain an SQL query (52), which causes an external access to a database (5). When the database reply is received, processing is resumed on this exception match and the remainder of the answer function is executed, which can comprise some text to be output (53) to the user.

The present invention relates to methods and apparatus for interpreting and responding to short text messages, such as, for example, text messages transmitted in a mobile communications system. It has particular, but not exclusive, application in the fields of information storage and retrieval by text, and in the provision of text-based interfaces, that allow users to interact with automated systems, for example, and particularly, in the field of mobile telecommunications.

Communication using text messages, such as SMS messages in a GSM mobile communications system is nowadays very common and often a preferred form of communication. Its is becoming increasingly desirable therefore to provide services and applications that users can interact with via text messages. However, a difficulty with this is providing the ability to interpret and respond appropriately to a user's text messages. Ideally, it would be possible for a user simply to use natural language in their text messages, but it is difficult for an automated system to be configured to be able to interpret and respond to the range of possible natural language messages that a user could submit.

The Applicants have previously proposed in EP 1185119 an automated information system in which factual data in text form is stored hierarchically and can be queried using text messages via a hierarchical menu structure.

However, in this arrangement, the data must be organised manually into a suitable hierarchy, and the menu options must be created manually to allow the stored data to be navigated. This approach is very labour intensive and while it may be suitable for smaller, closed applications with a very limited data set, it is not suitable for more general text-based systems, where, e.g., the size of the data set may be very large or may grow over time.

AIML (Artificial Intelligence Markup Language) is an XML dialect aimed at natural language processing. However, the primary method of context memory used by AIML allows a matching rule to refer to a previous machine-output by using a tag. In order to use this method, a separate rule is required for every combination of new input and previous machine output, leading to a combinatorial explosion of complexity in the rule set. This means that this method is not realistically scalable, since every new output added could potentially require a large number of new context rules to be added.

Prolog is another computer language that has been applied to language processing. Prolog is rule based, and lends itself to logical processing of grammars based on a set of construction rules. However, language tends to be irregular and Prolog is unsuited to dealing with such irregularity.

Indeed, the Lighthill Report (Professor Sir James Lighthill, “Artificial Intelligence: A General Survey”, UK Science Research Council) stated that AI researchers had failed to address the issue of “combinatorial explosion” when solving problems within real-world domains. In other words, while traditional AI techniques could work within the limited scope of small problem domains, the techniques would not scale up when applied to more realistic problems, such as natural language processing. This applies to both AIML and Prolog.

The Applicants believe therefore that there remains scope for improvements in the field of text message processing, in particular in relation to the provision of automated service and applications that can be controlled and interacted with via text messages.

According to a first aspect of the present invention, there is provided a method of processing an input text message in an automated text message processing system in which are stored a plurality of exceptions to be matched against input text messages, each exception defining at least one text string that a text string derived from an input text message must match for the exception to be matched and having associated with it an answer function that is to be executed in the event of the exception being matched, the method comprising:

the system:

receiving an input text message;

searching sequentially through some or all of the stored exceptions for a match between a text string derived from the input text message and the text string or strings defined as matching to an exception; and

executing an answer function that is associated with a matched exception.

According to a second aspect of the present invention, there is provided an apparatus for interpreting and responding to a text input message received by the apparatus, the apparatus comprising:

means for storing a plurality of exceptions to be matched against input text messages, each exception defining at least one text string that a text string derived from an input text message must match for the exception to be matched and having associated with it an answer function that is to be executed in the event of the exception being matched;

means for receiving an input text message;

means for searching sequentially through some or all of the stored exceptions for a match between a text string derived from the input text message and the text string or strings defined as matching to an exception; and

means for executing an answer function that is associated with a matched exception.

In the present invention, an input text message is processed and interpreted by using a matching technique that matches a text string derived from the input message against a set of exceptions until a match is found. When a match is found, an answer function that is associated with the matched exception is executed.

The exceptions of the present invention can be thought of as string representations against which input messages are tested, but unlike in systems such as Prolog, the exceptions do not try to represent the construction rules of language, but rather each define a particular input (or set of inputs, as will be discussed further below) against which the input text message should be matched.

The effect of this is that the present invention processes and interprets the input text messages by relating them to the exceptions or irregularities of the input text (language), rather than trying to use the regular rules of language to do so.

This has the advantage that, as will be discussed further below, the present invention will not, inter alia, suffer from the “combinatorial explosion” problems faced by the prior art techniques, and can therefore provide a more suitable system for larger data sets, and a system to which new data, etc., can more easily be added. The invention is also particularly flexible in its use, and can provide a powerful means for quick and effective text interaction with automated systems.

Indeed, the Applicants have in particular recognised that as language is irregular, and the irregularities can significantly outweigh regular constructions in natural language, the processing of text by relating it to irregularities in language (which is what the use of exceptions in the present invention does) can be particularly advantageous. Moreover, the present invention provides particularly effective techniques for doing this.

The exceptions that are used in the present invention effectively represent, as will be appreciated by those skilled in the art, possible inputs from a user so that it can then be determined whether a current user input corresponds (matches) or not. The exceptions define at least a text string that is to be matched against a text string derived from an input text message, but may otherwise be configured as desired.

The text string that is derived from an input text message and compared to the exceptions may, e.g., simply comprise all or part of the text message in the form that it is sent by the user.

However, in a preferred embodiment, the matching process for matching an input text message with the text string(s) of an exception comprises first processing the text of the input text message (i.e. the text of the message as sent by the user) to a derived form for the purposes of the matching search. This preferably comprises rendering the input text message with a predefined character set, entirely in lower case, removing any redundant white space, and/or removing any accents in the input text message.

Preferably a predetermined standard character set is used for all inputs to the exception matching process, and input text messages are converted or mapped to this standard, predefined character set before being submitted to the matching process. For example, character mapping tables could be used to map accented characters to a standard character set.

Other arrangements, would, of course, be possible.

The text strings defined for exceptions are similarly preferably defined (and stored) in a corresponding, preferably standardised, form (e.g. using a predetermined, standard character set).

The text string(s) that will be considered to match an exception may be defined in any suitable way. In a preferred embodiment this is done by including syntax denoting the text string or strings in the exception. For example, the exception can itself include the text string that it is to match to.

Once the input text has been rendered to a derived, e.g., standardised, form (where that is done), it is preferably then attempted to be matched against the text strings defined for some or all of the stored exceptions. This is preferably done by determining if there is a match between all or a part or parts of the input text message and all or a part or parts of the text string(s) defined as matching to the exception(s).

Any suitable text matching process can be used for this purpose. Preferably exceptions are matched left to right, and an exception can preferably be split into several parts with each part being compared in turn. It is preferably also possible for individual words or parts of text strings in exceptions to be matched, e.g. even if the entire text string may not be matched.

In a preferred embodiment, it is possible for exceptions to have as their criteria for a match with an input text message solely a requirement that a text string defined as matching with the exception is matched with a text string derived from an input text message, or to have both a requirement that a text string associated with the exception is matched with a text string derived from an input text message and some further requirement or requirements, such as a time or date condition, that must be met for a match to be considered to be made (this will be discussed further below).

In a preferred embodiment, as well as the exceptions that match to defined text strings, there may be one or more exceptions that do not have matching text strings defined for them but instead have other forms of matching criteria only.

In a particularly preferred embodiment, one or more of the exceptions solely require an input text message string to match with a text message string defined as matching with the exception for the exception to be matched.

In one preferred embodiment, one or more of the exceptions define, and preferably comprise, a sequence of text, such as “i have a new address”, that is to match literally with a string of text derived from an input text message for the exception (or its text string requirement, as appropriate) to be matched.

In a particularly preferred embodiment, a given single exception can be defined as matching to a plurality of different input text strings.

In one preferred arrangement this is achieved by the exception including two (or more) text strings that are defined as alternatives and for which a match with any one of the defined alternatives will match the text string of the exception.

In a preferred embodiment an exception may include a “wildcard” that is to be considered to match any text (that is in the appropriate place) in the input text string (i.e. the “wildcard” in the exception will be considered to be matched whatever the relevant input text is (and thereby allow the remainder of the input text string to be matched to the remainder of the exception text string (if it does so)).

In a particularly preferred embodiment, an exception can be defined as matching to any input text string. This may be done, e.g., by solely including a “wildcard” as the text string requirement for the exception. Such an exception would then match to any text input, and so could be used, e.g., to trigger a default answer function in the event that no more specific exceptions are matched.

It should similarly be appreciated here that in the present invention exceptions can accordingly preferably be defined as matching to a single text string only, as matching to a plurality of different text strings, or as matching to any input text string (i.e. to an infinite number of different text strings).

In a particularly preferred embodiment the text string or strings defined as matching to an exception can include a defined class (set) of text strings, such that if the appropriate characters in an input message text string match any member of the indicated class that part of the exception will be considered to be matched (i.e. will allow the remainder of the input text string to match the remainder of the exception (if it does so)). This is preferably done by including in an exception an indicator (a class identifier) that identifies the desired class (set) of text strings.

Thus, in a preferred embodiment a plurality of classes, each class having one or more members, are defined and can be referenced in an exception to be matched. Similarly, in a preferred embodiment one or more classes of text strings can be defined, each class comprising one or more members, and each member of a class defining a text string or strings that is to be considered to match to the class, and an exception may require a part or parts of a text string derived from an input text message to match to one or more of the defined classes of text strings for the exception to be matched.

This allows classes that contain one or more members with each member defining or indicating a text string that is considered to be a match to the class to be defined and stored, but referenced (used) in exceptions simply by indicating the relevant class for the exception (e.g., and preferably, by including the relevant class identifier in the exception), rather than having to list each class member in the exception (or in different exceptions) individually. A class thus, in effect, defines a set of things to match against for an exception.

The use of “classes” in exceptions in this manner accordingly provides a level of indirection in the exception matching that can for example facilitate more flexible definitions of exceptions to be matched. It can also allow a given single or few exceptions to match a large number of potential input messages (text strings).

It also means that the number of possible allowed inputs to the system can be increased by adding new members to an existing class and/or by adding a new class, as well as by adding new exceptions. This greatly increases the flexibility and power of the system.

Preferably the system supports and uses a plurality of classes. Similarly, an exception can preferably include a plurality of classes, if desired.

Each class may include as many entries as desired. The members of (entries in) a class are preferably related to each other, e.g. in terms of their subject-matter, but this is not essential. A class can preferably comprise a set of different text strings.

In a particularly preferred embodiment, the system includes a plurality of classes that can be used together to represent possible sentence forms, for example, and preferably, by including the classes appropriately in sequence in an exception. For example, there may be, and preferably is, one or more classes whose members are possible forms of a given verb, whose members are possible subjects, locations, times of day, etc., and/or whose members are possible adjectives or adverbs, etc. Then by including these classes in exceptions in the appropriate order, an exception can, for example, be matched, irrespective of the form of the particular verb used in the input text message. Similarly, depending on the exception and classes that are matched, the context of a user's input sentence may be derived (and, e.g., and preferably, then stored for use in subsequent exception matching and answer functions).

Thus, in a particularly preferred embodiment, one or more exceptions include sequences of classes that together define a set of sentence forms that will be considered to match to the exception.

In a preferred embodiment, class members can include or be defined using other exception syntax, for example to show that the member or a part of the class member is optional.

In a preferred embodiment, the entries in (members of) a class are sorted to allow more efficient searching through the class, for example, using a binary-chop search method.

In a preferred embodiment, a class indicated for an exception (a class identifier in an exception) can be defined (marked) as being optional. In this case the class “requirement” of the exception text string will also be matched by zero characters in the appropriate part of the input text string (since the class is optional), such that if there are no characters in the relevant part of the input text message, the indicated class for that part of the exception will be considered to be matched (i.e. will allow the remainder of the input text string to match the remainder of the exception (if it does so)).

Indeed, it is in general preferred that parts of exceptions, such as parts of text strings defined for exceptions, can be defined as being optional, i.e. such that they do not need to be present in an input text message for the exception to be matched.

In a particularly preferred embodiment, a class can itself include another class as a member. This is preferably achieved by including the appropriate class identifier(s) as a member of the class. Such “super” classes (i.e. classes that include classes among their members) can be used to provide a further level of indirection. Preferably a “super” class can contain both “class identifier” members and “normal” class members.

Such a “super” class preferably includes one or more other classes. An exception that includes the class identifier for this “super” class will then match to (in respect of that part of the exception) any member of the one (or more) classes that the indicated “super” class is defined as including. In other words, in this arrangement, if the appropriate characters in the input text string match any entry in any one of the classes included in the, class identified in the exception, that will be considered a match to that part of the exception and will allow the remainder of the input text string to be matched to the remainder of the exception (if it does so).

In a preferred embodiment, a super class can be defined as including plural classes.

Preferably a super class can be defined as including plural classes but only if the classes are present in a particular sequence or sequences (order). This is preferably done by denoting a super class member as being the classes in question in the desired order. For example, a super class “dates” could have as two of its members “month/day/year” and “day/month/year” (where “month”, “day” and “year” are classes) to allow “dates” to match to dates input in an appropriate format (order) but not otherwise. In other words, a super class can preferably include as a class member, a “nested” set of classes.

In a particularly preferred embodiment, an exception can include a plurality of class identifiers (reference a plurality of classes) in its matching criteria (text string(s) to be matched). Each such instance of a class to be matched in an exception may be the same or a different class. In a preferred embodiment, an exception can indicate that a given class may appear multiple times in an input text message, without the need to list the class multiple times in the exception.

In a particularly preferred such embodiment, if an exception includes two instances of a given “super class” (i.e. a class that has classes as or among its members) in its matching criteria, the exception can be configured such that it will only be matched if each “super” class match is matched by a member of the same class that is a member of the “super” class. In other words, if a given “super” class identifier is used two or more times in the same exception, the particular class whose entry is matched by one instance of the “super” class identifier may, and preferably does, restrict the list of classes of the given “super” class that may be matched by another instance of the given “super” class identifier in the exception.

This would allow, for example, only text inputs that are related in a way that makes sense to cause the exception to be matched. For example, a “super” class “units” that has for its members, inter alia, the classes “lengths” and “volumes” could be used in this way to allow an input such as “How many metres in a mile?” to match the exception (since “metres” and “miles” are both in the class “lengths”), but to not allow the input “How many litres in a mile?” to match the exception (as “litres” and “mile” are not in the same class in the superclass “units”).

In a preferred embodiment, an exception can indicate that a class member must be present in the input text string for the exception to be matched, or it can indicate that a class member must not be present in the input text string for there to be a match. Most preferably, an exception can indicate that (a part of) the input text string must match (exist in) one or more classes but not match (exist in) one or more other classes for the exception to be matched. This can be particularly useful for reducing the number of exceptions that may be required to cover a given domain.

In a particularly preferred embodiment, entries in classes can and do have associated with them some additional information that can also be used in relation to the class entry, for example for the purposes of exception matching and/or in an answer function.

In one preferred embodiment, the information that may be and is associated with a class entry is a particular, preferably predetermined, preferably standardised, or “root” form of the entry. In this case, this “root” form associated with the class entry may be the same as the class entry itself (and in a preferred embodiment the default position is that this root form of a class entry is the same as the text string representing the class entry unless a different root form is defined).

As will be discussed further below, this root form of a class entry may be, and preferably is, used in responses to users so as to provide a standardised response form for the class entry in question. For example, a class entry may be “fiance”, and the root form may be “France”.

In a particularly preferred embodiment, a class entry can have multiple different forms of information, such as root forms, associated with it. Preferably any different root forms associated with a class entry are defined as alternative allowed root forms for the class entry in question.

It is also preferred that if a given class entry (member) belongs to more than one class, the additional information (if any), such as a root form, associated with the class entry may be different in different classes.

In a particularly preferred embodiment, the additional information associated with a class entry can be and preferably comprises a class identifier. This, in particular, in combination with the use of a plurality of additional information for a given class entry, may be particularly useful where, for example, a given word or term may have two or more different meanings and, e.g., accordingly belong to two or more different classes. For example, the word “manx” could be a member of the class “cats” and of the class “language”.

In this case one could also define a further class which has such words as its members, and for which the additional information associated with those class members is the different classes that the class member is a member of. Thus “manx” for example, may in this class be associated with the information “cat|language” (where “|” indicates alternatives). Testing against the additional information associated with “manx” in this class could then, e.g., allow an exception to be matched appropriately whether “manx” is being used to mean a language or a cat.

It is believed that the use of a class that associates with its class entries the class identifiers of all the other classes that that entry is a member of may be particularly advantageous. Thus, in a particularly preferred embodiment, the system includes a class that has as its members words that are members of other classes, and that has associated with each member of this class the class identifiers of each other class that the class member is a member of. Most preferably the system is able to construct such a class automatically by analysing the other classes of the system. This will then provide a class in which information associated with its class entries (members) identifies all of the (other) classes in which the class entry in question occurs.

It is believed that such arrangements may be new and advantageous in their own right.

Thus, according to a third aspect of the present invention, there is provided a method of constructing a data structure for use in a text processing system in which input text messages are tested against one or more exceptions to find a match to an exception and in which a plurality of classes, each class having one or more members, are defined and can be referenced in an exception to be matched, the method comprising:

determining class members that are members of more than one class;

constructing a further class that includes such class members as its members; and

associating with each member of the constructed class, information indicating the other classes that that class member is a member of.

According to a fourth aspect of the present invention, there is provided an apparatus for constructing a data structure for use in a text processing system in which input text messages are tested against one or more exceptions to find a match to an exception and in which a plurality of classes, each class having one or more members, are defined and can be referenced in an exception to be matched, the apparatus comprising:

means for determining class members that are members of more than one class;

means for constructing a further class that includes such class members as its members; and

means for associating with each member of the constructed class, information indicating the other classes that that class member is a member of.

As will be appreciated by those skilled in the art, these aspects and embodiments of the invention can and preferably do include any one or more or all of the preferred and optional features of the invention described herein, as appropriate.

In a particularly preferred embodiment, a class can be associated with another class or classes, such that if the class is included in an exception, the associated class or classes are also searched for a match when the exception is tested. This will allow, for example, classes made up of “aliases” to members of a given class to be associated with the given class, so that, for example, the “alias” classes are also searched when the main class is searched.

Thus, in a preferred embodiment, it is possible to define “Alias” classes, whose entries (members) are aliases for one or more entries in an associated “main” class, and in which information associated with an entry in an alias class indicates, and preferably is, the entry of the “main” class that is being aliased, and/or the standard (root) form associated with the “main” class entry. This would then allow, e.g., a matched “alias” class entry to take the system to the appropriate main class entry. For example, a class “planets” could include “mars” as an entry, and have associated with it an alias class “planet alias”, that includes the entry “red planet”, with “red planet” being associated with “mars”.

Preferably, where classes are associated in this manner, all the associated classes are automatically searched whenever the main class is to be searched for an exception.

In a particularly preferred embodiment, text included in an input text string that is matched to an exception can be stored as a variable for future use by the system. For example, and preferably, the class entry (member) that is actually used in an input text string that matches to an exception can preferably be stored as a variable for further use e.g., in future exception matching and/or for use when responding to the user. In other words, an exception can preferably specify that a class entry (member) used in the input text string that matched to the exception is to be stored as a variable. Similarly, if a “super” class that includes other classes as its members is matched, preferably the class (the class identifier) of the matching input entry and/or the matching input entry itself, can be and preferably are, stored as variables for future use by the system.

Input text that is stored as a variable is preferably stored in the original case as entered by the user, although preferably any redundant white space is removed.

In a particularly preferred embodiment, a variable that stores a matched class entry preferably has associated with it a corresponding “shadow” variable that stores the root form of the class entry (as discussed above). This facilitates using the root form of the class entry when it is required.

In a preferred embodiment, there are plural variables available, each of which can be allocated a given input text string as desired.

In a particularly preferred embodiment of these arrangements of the present invention, an exception can indicate the input text portion that is to be stored (if the exception is matched) and the identity of the variable in which the input text is to be, stored. In response to this, if the exception is matched, the system will store the matched input text as the identified variable.

Similarly, an exception can preferably include'a variable identifier to indicate a requirement for the input to match appropriately the indicated variable if the exception is to be matched.

As discussed above, in a particularly preferred embodiment of the present invention an exception can include one or more other requirements that must be met for the exception to be matched, in addition to an input text string having to match a text string defined as matching to the exception. Such other “matching” requirements can preferably be defined in or associated with the exception. For example, and preferably, an exception could only be allowed to be matched at or between particular times and/or dates, only be matched by messages coming from a particular source or sources (e.g., from a particular user or users), and/or only be matched by messages that are directed to a particular destination or destinations (e.g., telephone number and/or short code).

Preferably any such additional requirement in an exception is tested first, so that the requirement or requirements effectively act as a “gate” which controls whether the exception is fully tested or skipped.

In a particularly preferred embodiment, such an additional matching requirement can be that a given variable has a text entry and/or has a particular text entry. This would then allow the exception to be matched only if, for example, it is appropriate in the light of the previous interaction(s) which set the variable being tested. This arrangement could similarly be used to, in effect, allow the system to conditionally execute or skip exceptions based on the context and history of the user's interactions.

For example, the required value of the variable could be set to something that represents the relevant history and/or context for the exception to be required, such that the exception will only be used if the appropriate context or history is active (since in that case the variable should have the appropriate value).

For example, a variable “topic” could be set to “history” as a consequence of the answer function of a matched exception (e.g. because it concerned a historical subject). Other exceptions could then include a matching requirement that the variable “topic” is set to “history”, so that they will be used when a user's previous interactions have been about “history” (have set “topic” to “history”) but at other times would be skipped.

These arrangements can be looked on as, in effect, allowing a previous interaction (e.g. user's input) to set a variable which is then tested in a subsequent exception to see if the variable has a particular value or not. Preferably exceptions can have answer functions that will set or clear these variables appropriately.

In a particularly preferred embodiment, exceptions can require (be defined as requiring) some criteria (requirement) not to be matched by the input text message for the exception to be matched. For example, as discussed above, an exception could require a class to be absent from the input text message for the exception to be matched. It would also, e.g., be possible to specify that an exception will exclude (not be matched by) inputs from a particular source or sources. (This may be more efficient than trying to define all the allowed input sources in an exception.)

Thus, in a preferred embodiment an exception can define that a part or parts or all of the exception must not be matched by an input text message for the exception to be matched.

The stored exceptions are searched sequentially looking for a match to the input text message. Most preferably, an input text message is tested against some or all of the stored exceptions one after another until a match is found.

In a particularly preferred embodiment, the exceptions are tested (searched through) in a particular, preferably predetermined, order. Most preferably the testing order of the exceptions is such that in general more specific exceptions (i.e. exceptions that have more specific matching requirements or constraints) are tested for a match before less specific (less constrained) exceptions.

The Applicants have recognised that it may be particularly advantageous to ensure that more specific exceptions are tested for a match before less specific exceptions, as this may help to avoid, for example, a match with a less specific exception masking the fact that a later, more specific exception (which if matched could provide a more appropriate answer function) would also be matched.

For example, taking exceptions that have as their required text string “my name is John” or “My name is {1}”, where “{1}” describes a wildcard that can have any value, then if the input text message is “my name is John” and the exception “my name is {1}” is tested first, the input text message will match that exception and stop the search, even though it might be preferable to match the input “my name is John” to the exception “my name is John” (e.g., so that an answer function more specific to people named John is triggered). The Applicants have recognised that in this case it would be preferable to test the input text message against the more specific exception “my name is John” before testing it against the more general exception “my name is {1}”.

Thus, in a particularly preferred embodiment, exceptions that have fewer possible matching inputs (i.e. that are more specific) are in general tested against an input text message before exceptions that have more possible matching inputs (i.e. that are less specific). However, it should be noted here that although it is preferred that the exceptions are in general tested in this order, within the overall testing sequence of the exceptions there can be cases where apparently less specific exceptions are tested before more specific exceptions.

Thus, in a particularly preferred embodiment, the order in which the exceptions are tested against an input text message is based on how specific each exception is. Preferably, the number and/or types of matching constraints defined for an exception is used as a basis for determining the position of the exception in the search sequence. Thus, in a particularly preferred embodiment, the invention includes determining the order for testing the exceptions on the basis of the number and/or types of constraints associated with each exception to be ordered or tested.

In a particularly preferred embodiment, different and/or particular forms of exception construction, and/or different and/or particular forms of constraints that may appear in exceptions, such as the use of classes, wild cards, etc., are defined as having particular, predetermined testing orders (levels of “specificity”) relative to each other. The exception testing order is preferably then determined based on these predefined relative testing positions of the different exception forms or constructs. For example, an exception including a particular construct, such as a class, may be tested after an exception that only requires a literal text match.

Literal text is preferably in general treated as more specific than classes, and classes are treated as being more specific than “super” classes (i.e. classes that have other classes or members).

Thus, in a particularly preferred embodiment, where a given input text string would be matched against an exception that will only be matched by that text string (i.e. requires a literal match to that text string), or against an exception or exceptions that will be matched by that input text string and by other text strings, the input text string is preferably tested against the exception that will only be matched by that text string (i.e. requires a literal match to that text string) before it is tested against an exception or exceptions that will be matched by that input text string and by other text strings.

Similarly, an exception that includes a given class in its matching requirements is preferably tested against an input text string before an exception containing a “super” class that includes the given class as a member (entry) is tested against the input text string.

The preferred testing order is preferably achieved by storing the exceptions in the desired order and searching through the stored exceptions appropriately (e.g., and preferably, top-to-bottom or bottom-to-top, depending on the storing order). However, it would instead be possible to have a search sequence that hops around the list of stored exceptions to achieve the desired testing order, if desired. Preferably, the system includes means for automatically sorting the exceptions into the desired order (i.e. into an order that will match appropriately the search sequence to be used when testing an input against the stored exceptions) and then storing them in that order. This may be done, e.g., and preferably, by using an appropriate sorting algorithm.

In a particularly preferred embodiment, the exception sorting (ordering) process is carried out by splitting the exceptions into different parts, preferably from left to right, and then comparing respective parts of respective exceptions to be ordered in turn, from left to right. If the respective parts of the exceptions differ in terms of how “specific” they are, then the exceptions are ordered (relative to each other) based on that. If the parts are the same, then the next parts of the exceptions are compared, and so on. Exceptions are preferably split into parts at least after each occurrence of literal text and/or at each class.

It is again believed that such these arrangements may be new and advantageous in their own right, for example, to facilitate the addition of new exceptions to the system.

Thus, according to a fifth aspect of the present invention, there is provided a method of constructing a data structure for use when processing text messages in a system in which an input text message is compared to a plurality of stored exceptions to see if a match can be found, the method comprising:

sorting a set of exceptions to be used in the system in accordance with a predetermined sorting scheme, and storing the sorted exceptions for use in the system.

According to a sixth aspect of the present invention, there is provided an apparatus for constructing a data structure for use when processing text messages in a system in which an input text message is compared to a plurality of stored exceptions to see if a match can be found, the method comprising:

sorting a set of exceptions to be used in the system in accordance with a predetermined sorting scheme, and storing the sorted exceptions for use in the system.

As will be appreciated by those skilled in the art, these aspects and embodiments of the invention can and preferably do include any one or more or all of the preferred and optional features of the invention described herein, as appropriate. Thus, for example, the exceptions are preferably structured as discussed herein, and have associated with them an answer function that is to be executed in the event of a match to the exception.

In these aspects and embodiments of the invention, the predetermined exception sorting scheme preferably sorts the exceptions such that more specific exceptions will (in general) be tested against an input text message before less specific exceptions, preferably in the manners discussed above. As discussed above, the sorting scheme should sort the exceptions to match the intended testing sequence to be used when testing an input text message against the exceptions, such as front-to-back, back-to-front, or a sequence that “hops” around the exceptions.

As discussed above, if an exception is matched to an input text message, an answer function associated with the matched exception is executed. Any suitable and desired answer functions can be defined and performed in the present invention. For example, and preferably, the answer function may be an operation to be performed, may trigger a query to an (internal or external) database, launch another program, etc.

In a preferred embodiment, a given exception may have an answer function that defines a plurality of functions and/or operations that are to be performed in the event of a match. Preferably some or all of an answer function may be conditional, i.e. is to be performed only if particular conditions are (or are not) met.

In a particularly preferred embodiment, one or more of the exceptions have answer functions that comprise the outputting of a text string by the apparatus, preferably to the user that provided the original input text message.

In a particularly preferred such arrangement, an answer function can include characters or a text string taken from an input text message in a text string to be output as (all or part of) the answer function. This is preferably done by identifying the variable that corresponds to the text string in the answer function text.

In a preferred embodiment, one or more of the exceptions have answer functions that define that the matched input text string should be modified and then the matching process continued (e.g. at its current point or at some other point such as restarted) using the modified text string. Such modifications of the input text string may comprise, e.g., deleting part of the input, correcting spelling mistakes, etc.

In a preferred embodiment, an answer function can store a given value, such as a text string (e.g. a word) in a defined variable. This may allow, e.g., the answer function to store the context or history of the user's interaction for future use.

Answer functions may also contain or define functions to be executed, such as mathematical and/or text manipulation functions.

Preferably, if no explicit match to a stored exception is found, a default answer function is executed.

In a particularly preferred embodiment, the system of the present invention can maintain a record of interactions with an, and preferably with each, individual user. Preferably a buffer of items that have been referred to in a particular, preferably selected, number of the user's (preferably most recent) previous interactions is maintained, preferably together with attributes of those items. Preferably a selected, preferably predetermined, number of such items is stored preferably on a first-in, first-out basis. Preferably, the variables saved (stored) from the last N executed answer functions are stored for each user, where N is an integer, and preferably predetermined, number, such as 10.

This can allow, e.g., ambiguous terms, such as pronouns, to be resolved by reference to the stored user's interaction history. For example, if an input or answer function referred to “King Charles”, then “King Charles” could be stored in a variable that is to be referred to, for example, if a later input from the same user uses a pronoun such as “he” or “his” to thereby allow the system to interpret the later input of “he” or “his” as referring to “King Charles” (in this case).

Thus, in a preferred embodiment, a record of a previous interaction (or interactions) with a user is maintained. This will allow, for example, context information from a previous interaction to be used to assist in interpretation of a later interaction.

Most preferably values (e.g. text strings) assigned to variables during exception processing for a given user are stored in a data store associated with the particular user and used (reloaded) for processing a subsequent query (interaction) from the same user. In a preferred embodiment, stored values assigned to variables for a given user are used to resolve (predict or estimate) the (intended) meaning of an anaphor (such as, and preferably, a pronoun) used in a subsequent input message from the user.

In a particularly preferred embodiment, the system logs details of input queries from users, and, e.g., and preferably, indicates those queries that were not matched successfully. This information could be used, e.g., for system improvement over time.

The present invention may be implemented as desired. In a preferred embodiment there is a processor or processing platform that will receive the input text messages and process them against the exceptions. This processing platform may itself store tables of exceptions, tables of classes, etc., and/or may have access, e.g., over a network, to such a store. It may also include appropriate exception sorting/ordering, class construction, user history storing, system logging, etc., functionality, as discussed above. This processing and functionality may be arranged on a single platform or in a distributed fashion, for example. Also, the sorting, compilation, etc., of the exceptions, etc., may be carried out on a separate computer and then loaded onto the system for use, if desired.

The system preferably also includes and/or has access to, one or more databases and/or knowledge tables for storing data that may be used, e.g., when testing exceptions, providing answer functions (responses), etc. It can preferably similarly include and/or access maths or other function engines as necessary.

In use of such a system, a user will send a text message which will then be communicated to the text message processing system in an appropriate fashion. The text message processing system will then pre-process the input text message to a derived form as discussed above and submit it to the exception matching process (engine) which will then test the input text message against a stored set or sets of exceptions until a match is found. The answer function associated with the matched exception will then be executed.

As will be appreciated by those skilled in the art, although the present invention has been described above with reference to the processing of an input text message, in practice the system and method of the present invention will be operable to receive and process plural text messages, and text messages from plural different users. In particular, the system can preferably process a series of text messages from a user, so as to, for example, provide a dialogue with a user.

Similarly in a preferred embodiment, the system of the present invention supports a plurality of services and/or applications that may be accessed via text messages in the manner of the present invention. Such different services and applications may have their own sets of exceptions and classes, etc., and/or they may share some or all of their exceptions and classes with other services and/or applications. Preferably a user can indicate which service or application they want, for example by sending a text message to a particular number or short code associated with that service or application.

In a preferred embodiment, new exceptions can be added to the set of stored exceptions. Similarly, new classes or class members can preferably be added to the system. Indeed, it is an important advantage of the present invention that it allows new data to be added to the system in this manner, since that does not cause the combinatorial explosion that besets traditional AI techniques.

Where additional material, such as new exceptions, classes and/or class members is to be added to the system, then this could either be required to be appropriately sorted, etc., before the new material is used (i.e. require a system “recompilation” before it is used), or it could be allowed to be added and used without first being sorted, etc., (i.e. in a non-compiled form), alongside the existing, sorted (compiled) data.

The present invention may be used in any system where (automated) text interaction may be advantageous, such as in personal or commercial information, service and/or application systems where users may desire to obtain information or interact with the system via text messages. It may be used in any system and situation wherein textual input may be supplied by a user to solicit an automated action, such as a text reply. Equally, the text input may be generated by or from the user in any suitable manner, such as directly in the form of text, or from the output of a speech to text synthesiser, etc.

A particularly preferred application of the present invention is to provide automated services and applications in telephony networks and in particular in mobile telephony networks and systems. Such telephony systems, particularly mobile systems, typically already have well-established facilities for communicating via short text messages and so the present invention can be particularly advantageously applied in such systems.

Thus, in a particularly preferred embodiment, the present invention comprises a mobile telephony system that includes the apparatus of, or that is operated in accordance with the method of, the present invention. Similarly, in a preferred embodiment, the text messages are in the form of mobile telephony (short) text messages, such as, and preferably, SMS messages.

Thus, according to a seventh aspect of the present invention, there is provided a system for providing an application or service that may be accessed and used via the sending of text messages in a mobile telephony network, the system comprising:

a text message processing system for the application or service comprising:

means for receiving an input text message;

means for storing a plurality of exceptions to be matched against input text messages, each exception defining at least one text string that a text string derived from an input text message must match for the exception to be matched and having associated with it an answer function that is to be executed in the event of the exception being matched;

means for testing an input text message sequentially against some or all of the stored exceptions for a match between a text string derived from the input text message and the text string or strings defined as matching to an exception; and

means for executing an answer function that is associated with a matched exception; and

the system further comprising:

means for identifying a text message sent by a user that is intended for the application or service and for directing the text message accordingly to the text message processing system for the application or service.

According to an eighth aspect of the present invention, there is provided a method of providing an application or service that may be accessed and used via the sending of text messages in a mobile telephony network, the method comprising:

the mobile telephony network identifying a text message sent by a user that is intended for the application or service and directing the text message accordingly to a text message processing system for the application or service, which text message processing system has access to a plurality of stored exceptions to be matched against input text messages, each exception defining at least one text string that a text string derived from an input text message must match for the exception to be matched and having associated with it an answer function that is to be executed in the event of the exception being matched; and

the text message processing system for the application or service:

receiving the input text message;

testing the input text message sequentially against some or all of the stored exceptions for a match between a text string derived from the input text message and the text string or strings defined as matching to an exception; and

executing an answer function that is associated with a matched exception. As will be appreciated by those skilled in the art, these aspects and embodiments of the present invention can and preferably do include any one or more or all of the preferred and optional features of the invention described herein, as appropriate. Thus, for example, the exceptions and answer functions can preferably be structured as discussed above, and the system may include, e.g. knowledge tables, access to external databases, exception sorting means, etc., as discussed above.

Most preferably the invention is implemented in a GSM or 3G mobile telephony system, and the text messages that are sent are SMS (Short Message Service) messages.

Where the invention is implemented in a GSM/3G system, then preferably so-called “direct” delivery of SMS messages to the system is used, so as to avoid the indeterminate delays which are inherent with an SMSC (Short Message Service Centre)-based architecture.

As will be appreciated by those skilled in the art, all of the above aspects and embodiments of the present invention can and preferably do include any one or more as all of the preferred and optional features of the invention described herein, as appropriate.

The methods in accordance with the present invention may be implemented at least partially using software e.g. computer programs. It will thus be seen that when viewed from further aspects the present invention provides computer software specifically adapted to carry out a method or the methods herein described when installed on data processing means, a computer program element comprising computer software code portions for performing a method or the methods herein described when the program element is run on data processing means, and a computer program comprising code means adapted to perform all the steps of a method or of the methods herein described when the program is run on a data-processing system.

The invention also extends to a computer software carrier comprising such software which when used to operate a communications system comprising data processing means causes in conjunction with said data processing means said system to carry out the steps of a method or of the methods of the present invention. Such a computer software carrier could be a physical storage medium such as a ROM chip, CD ROM or disk, or could be a signal such as an electronic signal over wires, an optical signal or a radio signal such as to a satellite or the like.

A number of preferred embodiments of the present invention will now be described by way of example only and with reference to the accompanying drawings, in which:

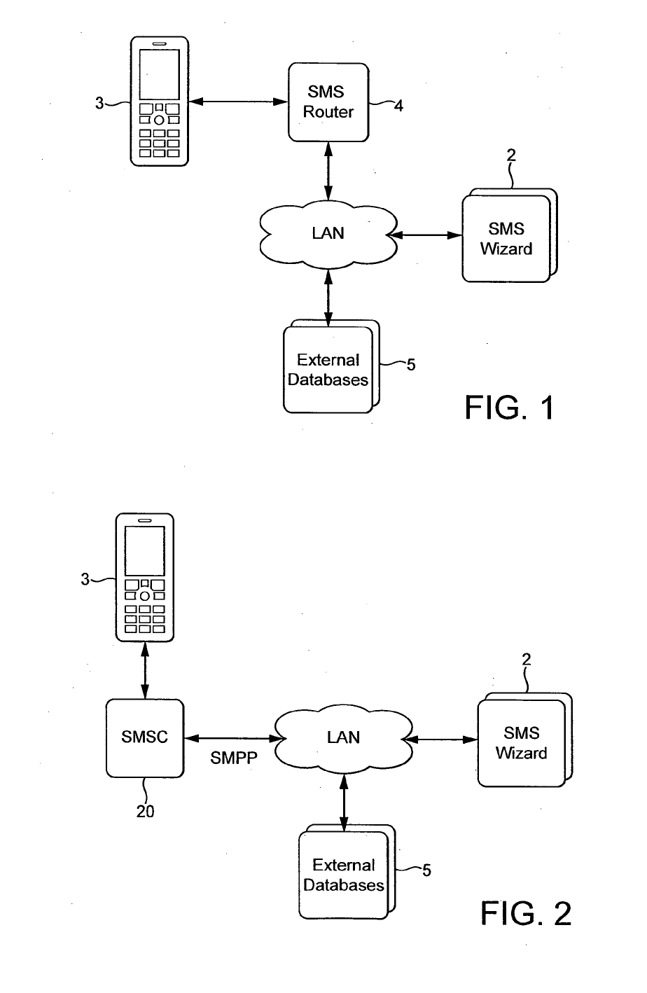

FIG. 1 shows schematically an implementation of the present invention in a telephone network;

FIG. 2 shows schematically an alternative telephone network configuration for implementing the present invention;

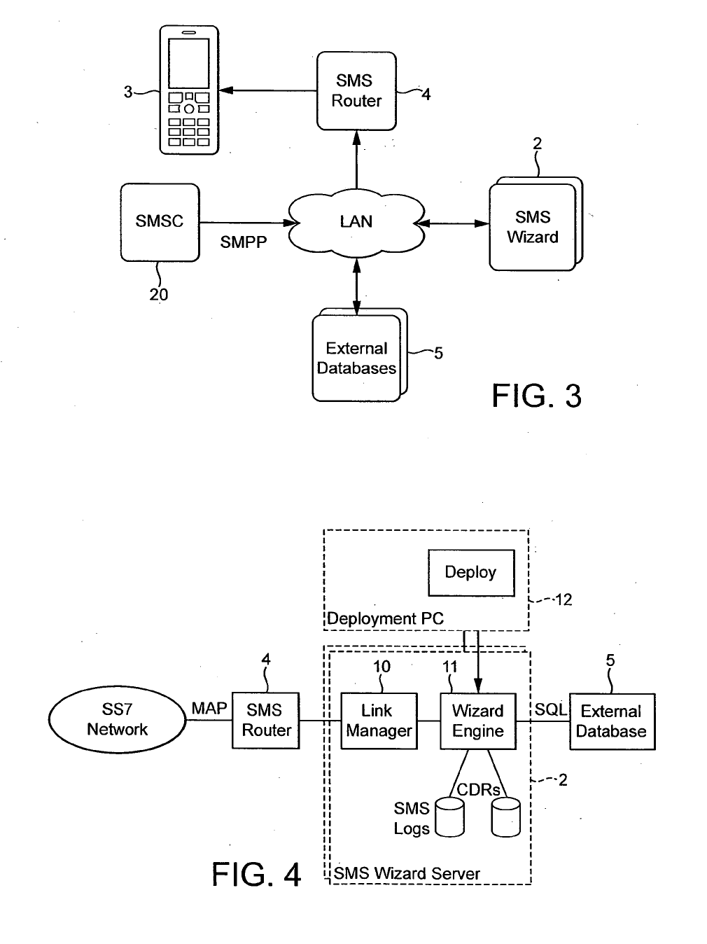

FIG. 3 shows schematically a further alternative telephone network configuration for implementing the present invention;

FIG. 4 shows schematically some components of the system of FIG. 1 in more detail;

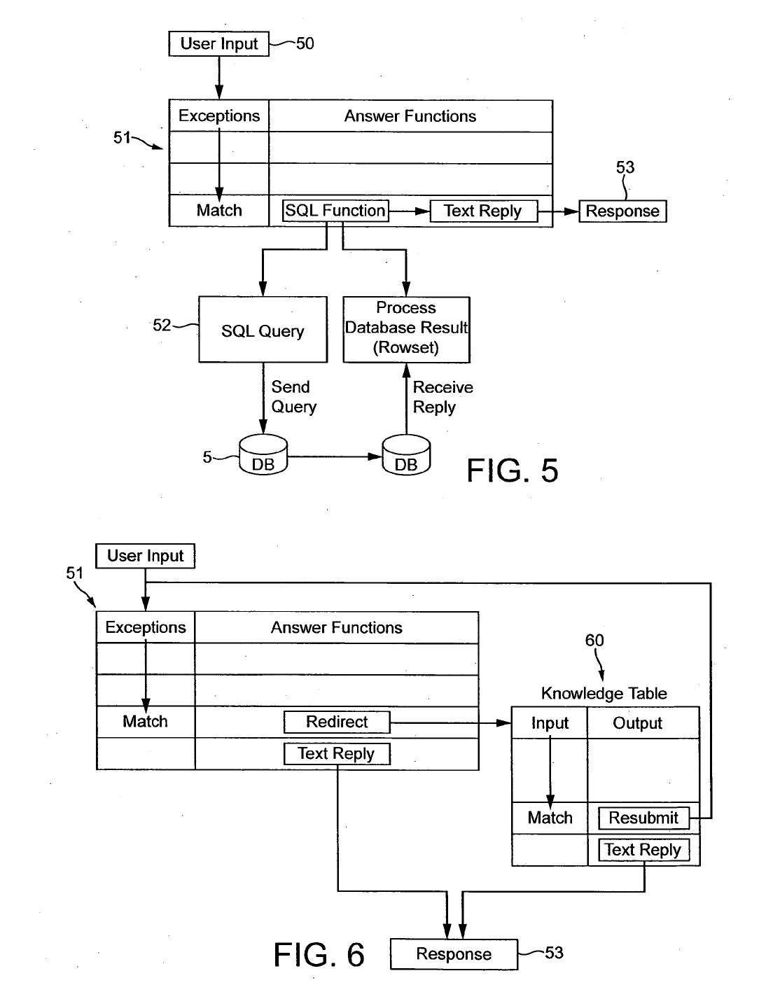

FIG. 5 shows an example overview of exception matching; and

FIG. 6 shows a further example overview of exception matching.

FIG. 1 shows schematically the implementation of a preferred embodiment of the present invention in a mobile telephone network.

In this embodiment, a server-based system 2, referred to as an SMS Wizard, is able to receive input text messages, such as SMS messages, sent by users via their mobile telephone handsets 3, and process and respond to those text messages in the manner of the present invention.

The SMS Wizard 2 may be used, for example, for applications including customer registrations, surveys, promotions, account queries and service discovery, as well as general customer care queries. SMS applications involving application automation could for example include a natural language text interface to a commerce application responsible for accepting parking fees or other tolls.

In the arrangement shown in FIG. 1, the SMS Wizard 2 is connected to the mobile telephone network using SS7 Mobile Application Protocol (MAP) via an SMS Router 4. This method of connection avoids the indeterminate delays which are inherent with an SMSC-based SMS architecture and enables provision of the fastest response and highest quality of service. Importantly, as is known in the art, when connected in this way, when ‘Message sent’ is displayed on the handset 3, it means that the message has reached the SMS Wizard 2, not just that it has been stored in an SMSC. The SMS Wizard 2 incorporates an input buffer to accommodate traffic peaks that may be associated with, for example, television promotions.

Thus, in the arrangement shown in FIG. 1, the SMS Router 4 has an SS7 MAP or SIGTRAN interface to the mobile telephone network and receives Mobile Originated (MO) SMS messages. It identifies messages destined for SMS Wizard 2 services, which for example in a customer care application would be typically addressed to the same short codes that are used for voice customer care services, and delivers them immediately to the SMS Wizard 2, preferably over TCP/IP.

The SMS Wizard 2 interprets the received message (this will be discussed in more detail below) and may pass an appropriate reply to the SMS Router 4, which delivers a Mobile Terminated (MT) SMS message directly to the handset 3 via an SS7 MAP interface. As the reply is virtually ‘immediate’, the handset 3 will normally be available to receive the SMS message; if it is not able to, the system performs automatic retries according to a pre-determined schedule. Connection of the SMS Wizard 2 via an SMS Router 4 also enables provision of advanced or alphanumeric services.

As shown in FIG. 1, there are in fact plural SMS Wizards 2. The SMS router 4 delivers SMS messages to the SMS Wizards 2 based on the User's CLI. This ensures that the same SMS Wizard receives all the traffic for a CLI. This is important because, as will be discussed further below, an SMS Wizard 2 may store dialogue history which can affect the response to the User. (Alternatively, a shared, e.g., central, database could be used to store the user data, etc.)

In the present embodiment, the SMS Router 4 routes traffic to a particular SMS Wizard 2 based on the last two digits of the CLI. This makes it possible to configure the SMS Router 4 to distribute traffic as desired between multiple SMS Wizards. This allows the SMS Wizard system to grow incrementally. The table below gives examples of such configurations:

| Number of SMS | |
|---|---|
| Wizards | SMS Router rules (last digits of CLI) |
| 1 | 00-99 |
| 2 | 00-49, 50-99 |
| 3 | 00-33, 34-66, 67-99 |
| 4 | 00-24, 25-49, 50-74, 75-99 |
| 5 | 00-19, 20-39, 40-59, 60-79, 80-99 |

If one of the SMS Wizards fails, the SMS Router 4 is configured to send this traffic to a fallback SMS Wizard.

The SMS Wizards 2 also have access to internal Knowledge Tables and external databases 5. Applications can be entirely self-contained, using internal Knowledge Tables, or they can utilise external databases for information such as account details. Data can be automatically extracted from a received message and written into an external database, for example registration information.

The various components of the system are linked to the SMS Wizards 2 by suitable network connections. FIG. 4 shows this in more detail.

As shown in FIG. 4, an external databases extension allows the SMS Wizards 2 to send queries to external databases 5 using a database access protocol. The database 5 may alternatively be accessed indirectly via a middleware application. The database queries can be in any language supported by the database or middleware provider. In a preferred embodiment the protocol could be OLE DB, ODBC or SQL.

A Link Manager component 10 manages connections to the telephone network and buffers incoming messages, while the Wizard Engine 11 component provides the processing of text messages and the generation of output. A deployment interface 12 for the environment is also shown that allows knowledge data to be loaded onto the SMS Wizards 2.

In the present embodiment, an SMS Wizard 2 fully processes each input message either itself or in conjunction with access to an external database or system. Whilst waiting for a reply from an external system, the SMS Wizard 2 can continue to process other input messages.

However, if a reply from an external system is very slow to arrive (there is preferably a maximum timeout for all external database queries), it is feasible that the same user could have sent in another input message, and for that to have been processed.

It is possible that this could lead to unexpected behaviour within a service, as the second message might use a storage variable, before the first message had completed its work on that variable. In some circumstances, this could lead to incorrect responses and incorrect information being stored in variables.

Each SMS Wizard 2 is therefore configured in this embodiment to ensure that each message from a given user is processed in the correct order by queuing up any further messages from the same user until the first message has completed. This avoids the possibility of a user's variables becoming corrupted by subsequent messages. Thus, messages from a given user are processed one at a time, and a second message is not accepted until the first message has been fully processed. This makes it impossible for messages to adversely interact under any circumstances, though of course processing of a subsequent message may be delayed until the first message has completed.

As the SMS Wizard is connected to the SS7 network by an SMS Router, then if a user sends a second message before the first message has been completed, they will see ‘Message not sent’ on their handset.

This feature also helps to protect the SMS Wizard 2 from a possible denial of service attack by electronic devices which may automatically send lots of messages into the SMS Wizard.

The SMS Wizards 2 maintain system logs. This makes it easy to identify aspects of a service which could be improved, since logs of requests that could not be interpreted or satisfied can be reviewed by the system operator and used as input to subsequent revisions of knowledge data or Exceptions.

Other connection and communication arrangements would be possible.

For example, as shown in FIG. 2, SMPP may provide a suitable means of connection to the SMS Wizard 2 via the host interface of an SMSC 20 (or a proprietary equivalent).

In this configuration, subsequent messages from a given user are not blocked (unlike where, as discussed above, messages arrive via an SMS Router). This is because with an SMPP connection, it is not desirable to reject messages from individual users. This is because SMSCs typically store messages on a per-destination number basis. If a message was rejected by the SMS Wizard 2, the SMSC will perform retries for that message according to its programmed schedule, and other messages for the same number will be delayed until the retry is successful or the full retry schedule is completed. This is undesirable as messages sent to the same number, by all other users, would be held up.

A further alternative connection option is illustrated in FIG. 3. In this case, the inbound messages to the SMS Wizard 2 pass through the SMSC 20 and are delivered via SMPP. However, replies to the handset 3 are delivered directly via an SMS Router 4. This ensures that output messages are delivered immediately if possible, rather than being subject to indeterminate delays through the SMSC, and also enables partial provision of alphanumeric services, i.e. alpha addressing for output messages.

When a text message arrives at an SMS Wizard 2, the destination number used by the sender 3 is used to determine which service to run by means of a lookup into a service table. If there is no match then a default service is run on the SMS Wizard 2.

As discussed, a given service or application has associated with it a set of exceptions which, in effect, define a set of matchable inputs from a user and corresponding (answer) functions to be performed in the event of the particular input.

The fundamental principle of the present embodiment is that an input text message is tested sequentially against a set of stored exceptions until a match is found (or no match at all is found). Once a match is found, an answer function associated with the matched exception is executed. In the present embodiment, if no match is found, a default match is assumed.

Each exception has defined for it, inter alia, a text string or strings that a text string derived from the input text message must match for the exception to be matched, and has associated with it a corresponding answer function for the exception.

An exemplary exception, together with its associated answer function is shown below:

| Exception | Answer Function |
|---|---|
| My name is John | Hi John, I'll remember that |

This exception will be matched by an input containing only the text string “my name is John” and will trigger as its answer function the sending of the text “Hi John, I'll remember that” to the user who sent the input message.

In the present embodiment, exceptions are case insensitive and their text looks exactly like user input text that has been pre-processed to allow the removal of variances caused by white space, character set, accenting and case. In the present embodiment, all exceptions are written in lower case.

The SMS Wizard 2 pre-processes the received input text in order to convert it to a standard character set (GSM SMS is normally only 7-bit), substitutes disallowed characters with space, removes redundant whitespace and converts the entire string to a consistent case to form an input text string to be matched. The SMS Wizard 2 then uses matching to examine each exception sequentially; if a match is found between an exception and an input string then the corresponding answer function is executed.

The matching process is algorithmic, since as well as containing literal text the exception syntax can include, as will be discussed further below, Wildcards (variables), Class Identifiers and “Super” Class Identifiers. These constructs can absorb variable numbers of characters from the input string in order to allow the remainder of the string to match the remainder of the exception. Generally, matching is done from left to right.

Simple exceptions, that require a literal match with an input test message, may be defined such as

hello

what is your name

i have a new address

Each exception is associated with an answer function that is executed if the exception matches. In the present embodiment, the answer function associated with an exception can have many capabilities. For example, an answer function can

Access an external database

Launch an external program

Forward the original or a modified input message transparently to a different destination address

Generate two or more outgoing messages to different destinations for one input message

Cause an external operation to be performed, such as an electronic payment action

Cause the match text to be modified and matching to restart or continue

Cause a Call Detail Record to be written to a log

Set the value of one or more temporary or permanent variables (Wildcards)

Cause a lookup to a Knowledge Table or an external database.

Create a text output from any combination of fixed text, variable (Wildcard) Contents and Knowledge Table lookup result.

Return text output to the sender

An answer function can contain a number of functions to be executed in the event of a match. In the simplest case, an answer function may contain literal text to be output. In a telecommunications application, answer functions may also for example be used to ‘no reply’, to send a text message, to send a ‘WAP push’ message, to send an MMS message, to send an Instant message or to initiate a Voice or Video Call.

A reply sent to a user may contain several components, such as fixed text, content based on the user input, and variable information from internal or external databases.

Answer functions may also contain functions, for example the function [n/empty] which determines whether the variable (Wildcard) n is empty and then conditionally executes an associated part of the answer function. Similarly engines may be used in answer functions to provide specialised resources which are not suitable for Knowledge Tables. For example a Maths Engine can be used to perform calculations or answers relating to mathematical queries. Answer functions can'also contain text manipulation functions, for example pluralizing, singularising, or switching gender or person. For example a question phrased with ‘I’ might require an answer phrased with ‘you’.

The answer function may define literal text to be returned to the user and it may also contain variables populated by the exception during the present matching operation or previously.

Several functions are available for substituting or changing (e.g. deleting) text in the input string in order to create an output string. Also an answer function can specify that its output should be resubmitted to the exception matching process either recommencing from the beginning or resuming from the next exception or elsewhere. This is particularly useful for reformatting an input string to for example remove redundant or unnecessary words, to rationalise a number of variants of a word or phrase into a single standard variant, or to correct common errors.

It is also possible to jump to a specific exception to continue processing.

In this way iterative processing of a text string is possible, where some exceptions are responsible for standardising the form of a query, while others generate output or actions for responding to the user's request. This can result in very powerful text processing capability with relatively few exceptions.

FIG. 5 shows an example overview of exception matching. User input 50 is matched against a list 51 of exceptions sequentially until a match is found, and then the corresponding answer function is executed. If no explicit match is found, then the system automatically executes a default answer function. In this example the matched answer function contains an SQL query 52, which causes an external access to a database 5. When the database reply is received, processing is resumed on this exception match and the remainder of the answer function is executed, which comprises some text to be output 53 to the user.

FIG. 6 shows a further example overview of exception matching. In this example the matched exception has an answer function that contains a redirect to a Knowledge Table 60. The answer function specifies the input that is to be matched by the Knowledge Table, typically by providing one or more Wildcards (variables) that have been assigned during previous exception matching, and the Knowledge Table maps this input to an output that can be used in completion of processing of the present answer function, in generating a response 53 to the user, or in a string to be resubmitted to the exception matching process.

In the present embodiment, exceptions and answer functions can include variables known as Wildcards that can be used to match parts of the user input and to hold the matched text for later use. An important use of such Wildcards is that they are instantiated during matching, and then the instantiated value can be used during further matching within the same exception, or during processing of an answer function. This allows the instantiated information from a successful match to be passed to the associated answer function. For example, the following exception uses Wildcard (variable) 9 to capture any text submitted by the user following the string ‘my name is’.

| Exception | Answer Function |
|---|---|
| my name is {9} | Hi{9}, I'll remember that |

In this example, the input

My name is Levi

Would match to this exception, and result in the output

Hi Levi, I'll remember that

In the present embodiment, although the matching is done all in a consistent case, the text stored in a Wildcard has redundant white space removed but is in the original case as entered by the user.

In the present embodiment, exceptions can define sets or groups of things (entries), any one of which if present will match to that part of the exception.

This may be defined within an exception as a list of entries with separators between, such as in the following exception:

what is the {1/area|size} of france

In this exception the construct in {} defines the alternatives that will match to the exception. In this example the construct in {} will match to either ‘area’ or ‘size’ and place the matched one into variable (Wildcard) 1. This exception form can be viewed as being an “In-line class” and allows the efficient matching of alternative strings using a single exception.

It is also possible in the present embodiment to define data structures or classes that define a set or group of members or allowed matches to the class, and which can be referenced in an exception by the inclusion of an identifier for the class in the exception. Such classes, can be used, for example, to define a large group of similar entries. A class is primarily used as a restriction on the text that may be matched during exception matching.

The use of such classes allows indirection, and provides a very powerful means of increasing the efficiency of exceptions. For example, by the use of classes, an enormous number of possible input strings can be matched by relatively few exceptions.

In the present embodiment, such classes can be defined by the system developer or provider.

A simple example of a developer-defined class might be a list of country names, which could be defined as follows

Class country
france [France]
italy [Italy]
uk [United Kingdom]
united kingdom [The United Kingdom]
.
.
.

The optional entry suffix in square brackets is additional information associated with the class entry and is referred to in this embodiment as the “Root”. This will be discussed further below.

For this class, the class identifier is “country” and it could be used in an exception as in the following example

what is the capital of {1/*country}

In the preferred syntax used here, the “1” is an arbitrary Wildcard (variable) number, the “/” is a separator and the “*” indicates that the following term or token is a class identifier. The user input matches this exception text string only if the input text following “what is the capital of matches one of the entries in the class “country”. If a match is found; the matched entry is assigned to Wildcard (variable) 1.

The present embodiment also includes a number of predefined or built-in classes. Examples of these classes include

atoz—this matches to a single letter a-z.

word—matches to any number of letters a-z.

poundprice—matches to any monetary amount in GB pounds, such as “£1,234.56”, “£5000” or “56p”.

It is also possible for a class to include other classes as or among its members. In the present embodiment such a “super” class is referred to as a star class and represented by *Class and is a named set of developer-defined classes and/or built-in classes. For example the *Class “*world” could comprise—

Star Class *world
Europe
Asia

referring to two classes called Europe and Asia, each of which defines lists of associated countries. An example of the *Class “*world” in use in a fragment of an exception is as follows—

. . . {1/**world/21} . . .

which will match to any entry of a class whose name is listed in the *Class identified as “*world”, place the matched entry into Wildcard 1, and place the matched class identifier into Wildcard 21.

Exception processing may be further constrained so that where two or more *Class (star (super) class) matches occur in the same exception, the particular classes chosen from each *Class are constrained to be the same class. This is so that the items chosen from this super class are related in a way that makes sense. For example, such *Class constraints could be used to allow a units conversion query such as

How many metres in a mile?

to match and continue to a computation step, but

How many litres in a mile?

not to match because it doesn't make sense. While metres and miles are both found in the same class, say the class of “lengths”, litres and miles are not both found in the same class. The *Class used twice in this exception match could for example contain a list of classes for lengths, volumes, weights, speeds etc., but the whole exception will only match if the query uses two units from the same class.

In the present embodiment exceptions may also define class exclusions, whereby exception syntax can specify that a match may be required to exist in one of a number of classes but not exist in a number of other classes. This is a powerful technique for reducing the number of exceptions required to cover a given domain, for example matching to an address.

In the present embodiment, class entries are sorted to allow efficient searching, for example using a binary-chop search method.

In the present embodiment, as discussed above each class entry may have associated with it some additional information (a “Root”). The class entry may define a Root explicitly as a suffix to the class entry, as in the example above, otherwise the entry itself is used as the Root.

In the present embodiment, each Wildcard (variable) also has an associated shadow Wildcard which is automatically allocated the Root of a matched class entry when a class match is made and allocated to a Wildcard. Shadow Wildcards provide a powerful form of data reduction by allowing for variability in the input.

This allows the Root of the class entry to, e.g. be used in an answer function text, e.g. to ensure correct capitalisation. For example, continuing the previous example using the country class and the exception—

what is the capital of {1/*country}

for the input

What is the Capital of france

the shadow Wildcard could be used in the answer function to allow the properly capitalised Root (France) to be used in the output.

The Root can also be used in more powerful ways. In an embodiment, certain kinds of class may use multiple tokens in the Root, and the Root entries may themselves be class identifiers. As an example of how powerful this can be, the following simple exception classes can be used an illustration

Consider fragments of two classes:

Class cat
Manx
Tabby
.
.
.

Class language
Manx
French
.
.
.

and a class “wordtype” that uses the Root of its class entries to identify all of the classes in which defined words occur.

A fragment of this “wordtype” class would look like this

Class wordtype
french [language]
manx [cat|language]
tabby [cat] . . .

Preferably this class “wordtype” is automatically constructed by the system from the classes of the system, e.g., at compile time and/or as a background task while the system is in use. This may be done, e.g., by the system traversing the whole of the class data and then generating the class “wordtype” effectively as a reverse look-up table from the class data.

If Wildcard 11 is assumed to be the shadow Wildcard for Wildcard 1, then the following exception

is {1/*wordtype} a (2/{11}}

can now be used to match to the question

Is Manx a language

allowing the answer function to return a positive response.

This works as follows. The literal “is” is matched first. Then the class “wordtype” matches to “manx”, and so “manx” is placed in Wildcard 1, and the shadow Wildcard 11 is automatically loaded with the Root of “manx” in the class “wordtype”, which is “cat|language”. The literal “a” matches next, and finally “language” matches with the value of Wildcard 11 (as it contains (the in-line class) “cat|language”). The matching token “language” is placed in Wildcard 2. The whole exception has now matched, and so the corresponding answer function is executed.

In the present embodiment, a class can be associated with a so-called “alias” class or classes.

Each such “alias” class has entries (members) that are aliases for one or more entries in their associated “main” class. Each entry in an alias class also has associated with it information indicating the entry of the “main” class that is being aliased, and/or the standard (root) form associated with the corresponding “main” class, entry.

Where a class has an associated “alias” class or classes, then all the associated alias classes are automatically searched whenever the main class is to be searched for an exception.

This allows, e.g., a matched “alias” class entry to take the system to the appropriate main class entry. For example, a class “planets” could include “mars” as an entry, and have associated with it an alias class “planet alias”, that includes the entry “red planet”, with “red planet” being associated with “mars”.

As discussed above, the system of the present embodiment also includes a number of Knowledge Tables. These are tables comprising lists of paired information, inputs and outputs, which answer functions can access and derive outputs from. Following the previous example, the answer function could redirect to a Knowledge Table of country attributes, where the inputs are attribute and country names and the outputs are suitable output text for transmission to the user, as illustrated in the following example extract from a possible Knowledge Table

| Input | Output |
|---|---|
| capital/france | The capital of France is Paris |
| capital/italy | The capital of Italy is Rome |
| . | |
| . | |
| . | |
| Population/france | The population of France is 59.6 million |
| Population/italy | The population of Italy is 57.7 million |
| . | |
| . | |
| . | |

Alternatively, or additionally, a Knowledge Table output may comprise text to be resubmitted to the exception matching process, or redirected to a further Knowledge Table.

In the present embodiment, an exception can, as well as defining a matching text string or strings, include some other condition or criteria that must be met in relation to an input text message for the exception to be matched.

In the present embodiments these conditions or criteria are referred to as “gates” and are used to specify a condition (or conditions) that must be satisfied before the rest of the exception is tried. If the “gate” condition is not met, the rest of the exception is ignored. Thus, a “gate” is a conditional test that, in effect, determines whether an exception is tested or skipped in the matching process.

“Gates” can be thus used as a mechanism for providing topic focus or context in a dialogue. This is desirable if, for example, the user responds with a natural but ambiguous answer such as “yes”, where memory of the previous context may be desirable for correct interpretation.

In the present embodiment “gates” are denoted at the beginning of an exception, as follows:

[Gate condition] main part of the exception

In this exception “[]” denotes a gate condition to be tested to determine if the main part of the exception should be considered or not. An exception may have multiple gates, and if any of the “gate” Conditions are failed, the exception is ignored.

In the present embodiment gates can set conditions relating to the user's telephone number (such that only a given user or users will be allowed access to the exception in question). This is done by setting the gate condition to be a given telephone number or a class containing a set of telephone numbers. The gate syntax can indicate that it is the user's number that is to be tested.

It is also possible to set the destination number as a gate condition. For example, the exception:

[B/U123] main part of the exception

has a gate that restricts the exception to input messages sent to the destination short code of 123. (In this case, “B” denotes that a destination number is being set as the gate condition and “U” indicates that the number “123” is a short code.)

Gates can also be used to set time and/or date conditions for exceptions, if desired.

In the present embodiment, a gate can also be used to test whether a particular variable, such as a Wildcard, has been set to a particular value (e.g. text string) or not. This is done by identifying the variable in question and the value (e.g. text) it is to have to match the gate in the gate condition.

For example, the required value of the variable could be set to something that represents the relevant history and/or context for the exception to be required, such that the exception will only be used if the appropriate context or history is active (since in that case the variable should have the appropriate value).

This allows an exception to be matched only if, for example, it is appropriate in the light of the previous interaction(s) which set the variable being tested. This arrangement could similarly be used to, in effect, allow the system to conditionally execute or skip exceptions based on the context and history of the user's interactions.

For example, the exception:

[Topic/history] main part of the exception

has a gate (the terms between “[]”) that tests whether the variable “topic” has been set to “history” or not. This exception will then be used when a user's previous interactions have set “topic” to “history” but at other times will be skipped. The variable “topic” could, for example, be set to “history” as a consequence of the answer function of a matched exception (e.g. because it concerned a historical subject).

The system of the present embodiment maintains a record of interactions with each individual user, so that meaningful dialogues can be held. A short buffer of items that have been referred to during the most recent interactions is maintained, together with attributes of those items. Exceptions can then be used to resolve ambiguous terms, such as pronouns, by reference to the recent history in the buffer.

In this way, the context of a previous interaction can be used to assist in the interpretation of a new message, so that abbreviation, pronouns or assumptions common in natural language may be correctly interpreted in the new message.

For example a first message

Who was King of England in 1904?

Could return the answer

Edward VII was king of England from 1901 to 1910

While a further question

Who was his mother?

Could correctly interpret “his” to refer to “Edward VII”, and return the answer

Queen Victoria was mother of Edward VII

In this example, the history buffer retained information that a person, who was male and a king, called Edward VII had been referred to. The use of the pronoun “his” then tracked back through the history to find the most recent male reference, allowing resolution of the ambiguity.

The set of exceptions, classes, etc., for a given service or application is created and merged automatically and sorted by the system at compile time from a defined set of source files. The source files preferably comprise one or more tables stored in a standard database format, where each table may be an exception table, a Knowledge Table or a class table, etc. A predefined project definition file defines (lists) which source files are used in each service or application.

The exceptions and knowledge are stored in the form of lists in separate files according to type and topic. For example, lists of countries could be stored in a file defining the class “country”, while lists of exceptions defining how to respond to greetings could be stored in another file.

Because the exception list for a given service can be automatically merged and sorted from one or more source files in this way, that allows different bodies of rules and knowledge to be arbitrarily combined into a new service or application without the need to manually order or arrange the exception list.

The exception sorting is not merely alphabetical, but instead arranges the data such that it will be searched in the order of how “specific” each exception is. In particular, the exception list is sorted automatically and then stored, so that the stored exceptions will, in essence, be searched from most specific to least specific.

In the present embodiment, a front to back search of the exception list is carried out, so the exceptions are sorted into and stored in an order such that a front to back search of the exception list will search the exceptions in the desired order. Other sorting and storing orders and searching (testing) orders can be used if desired. In essence, the sorted, stored exception list should match the intended searching sequence so that the exceptions will be searched in the desired order of more specific to less specific.

The present embodiment seeks to ensure in this way that more specific exceptions are tested for a match before less specific exceptions, as this may help to avoid, for example, a match with a less specific exception masking the fact that a later, more specific exception (which if matched could provide a more appropriate answer function) would also be matched.

For example, taking exceptions that have as their required text string “my name is John” or “My name is {1}”, where “{1}” describes a wildcard that can have any value, then if the input text message is “my name is John” and the exception “my name is {1}” is tested first, the input text message will match that exception and stop the search, even though it might be preferable to match the input “my name is John” to the exception “my name is John” (e.g., so that an answer function more specific to people named John is triggered).

In general exceptions that have fewer possible matching inputs (i.e. that are more constrained) are considered more specific than exceptions that have more possible matching inputs (i.e. that are less constrained). However, it should be noted here that although it is preferred that the exceptions are in general sorted and tested in this order, within the overall sorting and testing sequence of the exceptions there can be cases where apparently less specific exceptions appear before more specific exceptions.

In the present embodiment, various permutations of exception construction are defined to have an ordering from most to least specific, such that the process of adding new exceptions to the list can be automated, preserving the sorted order.

Thus, different and/or particular forms of exception construction, and/or forms of constraints that may appear in exceptions, such as the use of classes, wild cards, etc., are defined as having particular, predetermined testing orders (levels of “specificity”) relative to each other. The exception testing order is then determined based on these predefined relative testing positions of the different exception forms or constructs. For example, an exception including a particular construct, such as a class, may be tested after an exception that only requires a literal text match.

Literal text is in general treated as more specific than classes, and classes are treated as being more specific than “super” classes (i.e. classes that have other classes or members).

During the sorting (compilation) process, exceptions are compared left to right and ordered. Exceptions are split after each occurrence of literal text and at each class into separate parts. Respective parts of respective exceptions to be ordered are then compared in turn, from left to right, and if the parts of the exceptions differ in terms of how “specific” they are, then the exceptions are ordered based on that. If the parts are the same, then the next parts of the exceptions are compared, and so on.

The following table shows the sorting (and testing) order for various types of exception construction used in the present embodiment:

| Exception | Kind of Exception |
|---|---|
| what is the capital of | fixed text exception - matches to “what is the |
| france | capital of France” only. |
| what is the capital of | inline class exception - matches to “what is the |
| {1/france\|germany} | capital of France” or to “what is the capital of |
| | Germany”. If a match occurs wildcard {1} |
| | contains “france”. |
| what is the capital of | Class exception. The class country contains a list |
| {1/*country} | of countries and so this exception will be matched |
| | by “what is the capital of ” any country in the |
| | class country. If a match occurs wildcard {1} |
| | contains the country used in the input. |
| what is the capital of | Super class (star class) exception. The super |
| {1 /**continent} | class “*continent” contains the classes “europe”, |
| | “asia”, etc. These classes have lists of countries |
| | (including “france” in the “europe” class). This |
| | exception will be matched by “what is the capital |
| | of ” any country in the classes in the super class |
| | “continent”. If a match occurs wildcard {1} |
| | contains the country used in the input. |
| what is {/\|the}capital of | Optional fixed text exception. In this exception |
| france | “the” is optional (denoted by the “\|”), so this |
| | exception matches to “what is the capital of |
| | france” or “what is capital of france”. Also, the |
| | match to “the” or not doesn't matter, so a |
| | Wildcard isn't needed for the result. |
| {1}france | Plain wildcard (i.e. matches any text - denoted by |
| | {1}) followed by fixed text exception. This |
| | exception will match to any text which ends with |
| | “france”. e.g. “where is france” |
| {/#france} | Unstructured exception (denoted by “#”). This |
| | exception will match if it can find the word |
| | “france” anywhere in the input text. E.g. “france |
| | and germany are adjacent” |
| {1} | plain wildcard only. This exception will match to |
| | any input. E.g. “hghgh gghfhjg” |

It should be noted here the exception “what is {/|the} capital of france” appears later in the sorted order in the above table because the ordering is done by comparing parts of respective exceptions working from left to right through each exception. Thus for the first five exceptions, the first part of each exception is “what” and so they cannot be ordered based on that. This results in the second parts of the exceptions, “is”, being compared. Again that doesn't differentiate the first five exceptions.

However, for the next part, “{/|the}” (i.e. “the” being optional) is less specific than the other exceptions which require “the” to be present to be matched, and so the exception “what is {/|the} capital of france” is deemed less specific when these parts of the exceptions are compared and so is placed later in the order. (The presence of classes, etc., in the other exceptions is not taken into account for this comparison, as it is just the relative “specificity” of the particular exceptions parts that are being compared that is considered.)

Following this, the first four exceptions that are all still “equal” continue to be tested, with the next parts of the exceptions being compared to see if they can be distinguished, and so on. Eventually, the final parts of the exceptions that require “france” or “{1/france|germany}” or “{1/*country}” or “{1/**continent}” will be compared, and the exceptions then ordered based on the relative specificity of those parts of each remaining exception.

As a further illustration of the'capabilities of the present invention, in its preferred embodiments at least, an example of how the present invention can be used to resolve anaphors will now be described.

An anaphor, as is known in the art, is an expression that refers to another. It can be difficult to resolve anaphors using automated language processing rules. An example of the linguistic problem of anaphors is the resolution of a pronoun such as ‘it’.

Suppose we read the sentence:

London had snow yesterday.

and then read one of the following sentences, all of which are sensible continuations. What is the it?

It also had fog. (It=London)

It fell to a depth of 1 metre. (It=the snow)

It will continue cold today. (It=the weather)

Handling pronouns is difficult, since the meaning of natural language cannot be determined in many cases from the meanings of words plus word ordering rules, without also applying wider knowledge.

A further problem is that even when the semantics of a sentence are determined, the actual intention may be otherwise. For example, if the question is—

Can you tell me the time?

### Then

Yes.

is not a useful answer, even though it may be syntactically and semantically perfectly correct. The question is actually a request to carry out an action.

Conversely, if the question is

Can you swim?

this would expect a Yes or No answer, rather than commencement of swimming. The distinction depends on the context not just on the words.

A further common example is illustrated by the following two sentences—

She ate the apple with a smile

She ate the apple with a bruise

A human listener has no difficulty in interpreting the intended meanings. However this requires world knowledge that people but not apples can have smiles; and while both apples and people can have bruises, without further context indicating the contrary, the bruise here refers to the apple.

The present invention, in its preferred embodiments at least, addresses this problem in a unique and innovative way. It matches the input to exceptions that contain sequences of classes corresponding to possible sentence forms. From the identity of the classes matched, the context of the sentence is implicitly derived, and this can be stored for use in subsequent answer functions.

An example illustrates:

The following exception matches to London had snow yesterday

| Exception | Answer Function |
|---|---|
| {1/*loc}{5/\|*vmod}{2/*tohave} | [/save/loc/{1}][/save/wprep/{3}] |
| {3/*wprep} | |
| {4/*time} | OK! |

Where the following classes are defined (amongst possibly many others):

| *loc | *tohave | *wprep | *time | *wcon | *vmod |
|---|---|---|---|---|---|
| London | have | rain | today | fog | also |
| Paris | Has | snow | tomorrow | cold | |
| | Had | | yesterday | | |
| | Will have | | | | |

| *wverb | *wmeasure | *height | *tobe |
|---|---|---|---|
| Fell | depth | 1 metre | am |
| | | 2 metres | is |
| | | 1 feet | are |
| | | 2 feet | was |
| | | 1 inch | were |
| | | 2 inches | will be |
| | | | will continue |
| | | | will continue to be |

From left to right, the exception matches London to an entry in the *loc class and puts the root, “London”, into Wildcard (variable) 1. The *vmod class is optional because of the “|” and doesn't match anything. Next had matches to an entry in the *tohave class and puts the root “had” into Wildcard 2 and so on.

The fact that this exception is matched tells us that we are dealing with a sentence involving a location. That fact is stored by the answer function saving Wildcard 1 into a variable arbitrarily called “toe”. Similarly, the precipitation type is stored into a variable “wprep”.

The system can save a number of such things in any answer function. The system maintains a ring buffer of the variables saved from the last N executed answer functions. (N is 10 in the present embodiment, but other values can be used if desired).

Suppose later in the dialogue, an exception containing a pronoun is matched. According to the particular exception matched, the meaning of the pronoun may be classified as, for example, a place or a precipitation type. The system can then look back in the ring buffer history to find the most recent save of a location name or a precipitation type, and infer the actual meaning of the pronoun.

For example the following exception matches

It also had fog. (It=London)

and replies

In London. Really!

| | |
|---|---|
| [L\|loc]{1/it}{5/\|*vmod}{2/*tohave}{3/*wcon} | [/save/loc][/save/wcon] |
| {4/\|*time} | In{L/loc}. Really! |

In this exception the “L” gate (L for last) tests whether the variable “loc” has been set (during the last N answer functions). If it is not set, then the exception is skipped.

However, in this case “loc” is set to “London” and so the rest of the exception is tested. The “{1/it}” matches to “it” or the value of Wilcard 1 (in this case “London”). The rest of the exception then matches to classes as before.

The answer function then replies

“In {value of “loc”, i.e. “London”). Really!”

The answer function also refreshes the save of “loc” and “wcon” for a further N exception matches.

The following exception similarly matches

It fell to a depth of 1 metre. (It=the snow)

and replies

Snow again. Really!

| | |
|---|---|
| [L\|wprep]{1/it}{5/\|*wverb}to {/\|a} | {L/wprep}again. Really! |
| {3/*wmeasure} of {4/*height} | |

The following exception matches

It will continue cold today. (It=the weather)

and replies

British weather!

| | |
|---|---|
| {1/it}{2/\|*tobe}{3/*wcon}{4/*time} | British weather! |

These three examples show how an anaphor (“it”) can be resolved according to context by using exception matching and a history buffer.

The power of the classes and exceptions can be further illustrated when a user says something like

It is going to be cold tomorrow

which doesn't currently match any exception. However simply by adding “is going to be” as an entry in the *tobe class, this verb variant is now covered and in future this input will match to the third example above.

As can be seen from the above, the present invention in its preferred embodiments at least, provides a scalable system that can respond to natural language text queries using data and exceptions stored in tabular form. The system is organised such that new data can be easily added to the system by adding or extending tables.

In particular, more exceptions and classes can be added as required, and while the size of the exception list and the class data may increase, this is only in a linear fashion and in particular the complexity does not suffer from the combinatorial explosion that besets the traditional AI techniques. This overcomes the criticism of AI in the Lighthill. Report.

The present invention, in its preferred embodiments at least, provides a highly flexible and powerful means for quick and effective text interaction with automated systems. The system can analyse the content of a received text string and provide an appropriate action and/or reply.

Input messages do not need to be in a fixed format as the present invention can handle natural language input. Therefore, as few demands are placed upon the user, service usage can be maximised.

The present invention has application in any situation where text interaction may be advantageous, for example personal or commercial information systems where users desire to obtain concise information easily or interact with an automated system, or where customer services interactions take place between users and organisations.

The invention has particular utility when accessed via the text messaging capability of a telephone network, such as a cellular mobile telephone network, wherein facilities for entering and receiving text using a personal device are already well established.

In this case, the present invention can be utilised in a variety of applications that involve text input derived from a short text message to solicit an automated action or a text output. The invention can allow network operators to reduce costs, improve quality of service, or build new revenue streams using a text messaging service such as the Short Message Service (SMS) of the GSM mobile telephony standard. For example, by offering an interactive text service, operators can provide their customers with an enhanced level of service, 24 hours a day, 7 days a week, at low cost and with maximum flexibility.

It can enable service discovery and easy access to multimedia content, since a number to dial or a WAP or web link can be returned to the user as means of referencing the desired information or service.

The invention can also, for example, be used to process a text query to a data resource on a public or personal computer system, such as in a Library or on a home PC, which could be conveniently be input via a keyboard or fixed terminal.

Indeed, the invention may be applied in any situation where textual input may be supplied by a user to solicit an automated action or a text reply. For example the text input may be provided from the output of an automatic speech recogniser.

1. A method of processing an input text message in an automated text message processing system in which are stored a plurality of exceptions to be matched against input text messages, each exception defining at least one text string that a text string derived from an input text message must match for the exception to be matched and having associated with it an answer function that is to be executed in the event of the exception being matched, the method comprising:
receiving an input text message;
searching sequentially through some or all of the stored exceptions for a match between a text string derived from the input text message and the text string or strings defined as matching to an exception; and
executing an answer function that is associated with a matched exception.

2. (canceled)

3. (canceled)

4. (canceled)

5. The method of claim 1, wherein:
one or more classes of text strings can be defined, each class comprising one or more members, and each member of a class defining a text string or strings that is to be considered to match to the class; and
an exception may require a part or parts of a text string derived from an input text message to match to a defined class or classes of text strings for the exception to be matched.

6. (canceled)

7. The method of claim 5, wherein a member of a class of text strings can have associated with it additional information that can be used in relation to the class member.

8. The method of claim 5, wherein there is at least one class of text strings whose members have associated with them information indicating another class or classes of text strings that the class member is a member of.

9. (canceled)

10. (canceled)

11. The method of claim 1, wherein different forms of exception construction, and/or of constraints that may appear in exceptions, are defined as having particular testing orders relative to each other, and the exception testing order is determined based on these predefined relative testing positions of the different exception constructs and/or constraints.

12. The method of claim 1, wherein one or more of the exceptions have answer functions that define that the matched input text string should be modified and then a search of exceptions performed using the modified text string.

13. The method of claim 1, comprising storing values assigned to variables during exception processing for a given user for use when processing a subsequent input message from the same user and using stored values assigned to variables for a given user to resolve an anaphor in a subsequent input message from the user.

14. (canceled)

15. An apparatus for interpreting and responding to a text input message received by the apparatus, the apparatus comprising:
means for storing a plurality of exceptions to be matched against input text messages, each exception defining at least one text string that a text string derived from an input text message must match for the exception to be matched and having associated with it an answer function that is to be executed in the event of the exception being matched;
means for receiving an input text message;
means for searching sequentially through some or all of the stored exceptions for a match between a text string derived from the input text message and the text string or strings defined as matching to an exception; and
means for executing an answer function that is associated with a matched exception.

16. (canceled)

17. (canceled)

18. (canceled)

19. The apparatus of claim 15, comprising:
means for storing one or more defined classes of text strings, each class comprising one or more members, and each member of a class defining a text string or strings that is to be considered to match to the class; and wherein:
an exception may require a part or parts of a text string derived from an input text message to match to one or more of the stored classes of text strings for the exception to be matched.

20. (canceled)

21. The apparatus of claim 19, wherein a member or members of one or more of the stored classes have associated with them additional information that can be used in relation to the class member.

22. The apparatus of claim 19, wherein there is at least one class whose members have associated with them information indicating another class or classes that the class member is a member of.

23. (canceled)

24. (canceled)

25. The apparatus of claim 15, wherein different forms of exception construction, and/or of constraints that may appear in exceptions, are defined as having particular testing orders relative to each other, and the exception testing order is determined based on these predefined relative testing positions of the different exception constructs and/or constraints.

26. The apparatus of claim 15, wherein one or more of the exceptions have answer functions that define that the matched input text string should be modified and then a search of exceptions performed using the modified text string.

27. The apparatus of claim 15, comprising means for storing values assigned to variables during exception processing for a given user for use when processing a subsequent input message from the same user; and means for using stored values assigned to variables for a given user to resolve an anaphor in a subsequent input message from the user.

28. (canceled)

29. A mobile telephony system comprising:
means for storing a plurality of exceptions to be matched against input text messages, each exception defining at least one text string that a text string derived from an input text message must match for the exception to be matched and having associated with it an answer function that is to be executed in the event of the exception being matched;
means for receiving an input text message;
means for searching sequentially through some or all of the stored exceptions for a match between a text string derived from the input text message and the text string or strings defined as matching to an exception; and
means for executing an answer function that is associated with a matched exception.

30. (canceled)

31. (canceled)

32. (canceled)

33. (canceled)

34. (canceled)

35. One or more computer readable storage devices having computer readable code embodied on the computer readable storage devices, the computer readable code for programming one or more computers to perform a method comprising:
receiving an input text message;
searching sequentially through some or all of the stored exceptions for a match between a text string derived from the input text message and the text string or strings defined as matching to an exception; and
executing an answer function that is associated with a matched exception.

36. An apparatus for interpreting and responding to a text input message received by the apparatus, the apparatus comprising:
a store for storing a plurality of exceptions to be matched against input text messages, each exception defining at least one text string that a text string derived from an input text message must match for the exception to be matched and having associated with it an answer function that is to be executed in the event of the exception being matched;
a processor for receiving an input text message;
a processor for searching sequentially through some or all of the stored exceptions for a match between a text string derived from the input text message and the text string or strings defined as matching to an exception; and
a processor for executing an answer function that is associated with a matched exception.

37. The apparatus of claim 36, wherein:
different forms of exception construction, and/or of constraints that may appear in exceptions, are defined as having particular testing orders relative to each other, and the exception testing order is determined based on these predefined relative testing positions of the different exception constructs and/or constraints.

38. The apparatus of claim 36, wherein:
one or more of the exceptions have answer functions that define that the matched input text string should be modified and then a search of exceptions performed using the modified text string.

39. The apparatus of claim 36, further comprising:
a store for storing values assigned to variables during exception processing for a given user for use when processing a subsequent input message from the same user; and
a processor for using stored values assigned to variables for a given user to resolve an anaphor in a subsequent input message from the user.
